(19) United States
(12) Patent Application Publication
(10) Pub. No.: US 2024/0231012 A9
(43) Pub. Date: Jul. 11, 2024

(54) FERRULE AND METHOD FOR MANUFACTURING FERRULE

(71) Applicant: FURUKAWA ELECTRIC CO., LTD., Tokyo (JP)

(72) Inventors: Masayoshi TSUKAMOTO, Tokyo (JP); Takahiro MIURA, Tokyo (JP); Masahiro HANDA, Tokyo (JP)

(73) Assignee: FURUKAWA ELECTRIC CO., LTD., Tokyo (JP)

(21) Appl. No.: 18/538,134

(22) Filed: Dec. 13, 2023

Related U.S. Application Data
(63) Continuation of application No. PCT/JP2022/023320, filed on Jun. 9, 2022.

(30) Foreign Application Priority Data
Jun. 17, 2021 (JP) 2021-101223

(51) Int. Cl. G02B 6/38; C08J 3/20; C08K 3/04; C08K 7/18

(52) U.S. Cl. CPC G02B 6/3854; C08J 3/203; C08K 3/04; C08K 7/18; C08J 2381/02; C08K 2201/005

(57) ABSTRACT

A ferrule is formed with an optical fiber insertion hole into which an optical fiber is inserted, and includes a resin composition containing a thermoplastic resin and a filler, wherein a size of coarse particles originated from the filler is 50 μm or less, or a size of aggregates originated from the filler is 50 μm or less.

### CROSS-REFERENCE TO RELATED APPLICATIONS

This application is a Continuation of International Patent Application No. PCT/JP2022/23320, filed Jun. 9, 2022, which claims the benefit of Japanese Patent Application No. 2021-101223, filed Jun. 17, 2021, both of which are hereby incorporated by reference herein in their entirety.

### BACKGROUND OF THE INVENTION

### Field of the Invention

The present invention relates to a ferrule and a method for manufacturing a ferrule.

### Background Art

Patent Literature 1 discloses a ferrule for an optical fiber, which does not use inorganic fillers such as silica and consists of a resin composition in which specific carbon particles are filled in a polyphenylene sulfide resin.

### CITATION LIST

### Patent Literature

Patent Literature 1: Japanese Patent No. 3354253

### SUMMARY OF THE INVENTION

### Technical Problem

However, in the ferrule for the optical fiber disclosed in Patent Literature 1, the material contains particles having a large particle size due to the filler, or the material contains aggregates having aggregated powders with a small particle size due to the filler, so that the homogeneity of the material may be impaired.

It is an object of the present invention to provide a ferrule excellent in material homogeneity and a method for manufacturing the ferrule in view of the problem described above.

### Solution to Problem

According to one aspect of the present invention, there is provided a ferrule formed with an optical fiber insertion hole into which an optical fiber is inserted, the ferrule including a resin composition containing a thermoplastic resin and a filler, wherein a size of coarse particles originated from the filler is 50 μm or less, or a size of aggregates originated from the filler is 50 μm or less.

According to another aspect of the present invention, there is provided a method for manufacturing a ferrule having formed with an optical fiber insertion hole into which an optical fiber is inserted, the method including: controlling particle size of a filler containing at least silica particles and carbon particles; preparing a resin composition containing a thermoplastic resin and the filler; and molding the resin composition to manufacture the ferrule comprising the resin composition, wherein a size of coarse particles originated from the filler is 50 μm or less, or a size of aggregates originated from the filler is 50 μm or less.

### Advantageous Effects of Invention

According to the present invention, it is possible to provide a ferrule excellent in material homogeneity and a method for manufacturing the ferrule.

### BRIEF DESCRIPTION OF THE DRAWINGS

FIG. 1 is a schematic diagram illustrating a ferrule according to an embodiment of the present invention.

FIG. 2 is a flowchart illustrating a method of manufacturing a ferrule according to the embodiment of the present invention.

### DESCRIPTION OF THE EMBODIMENTS

### One Embodiment

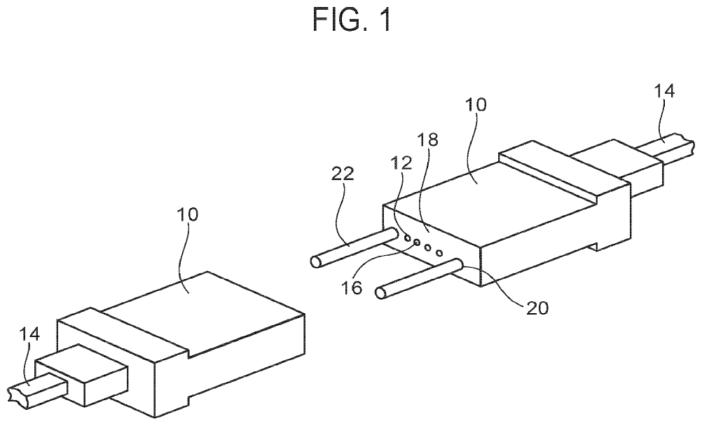

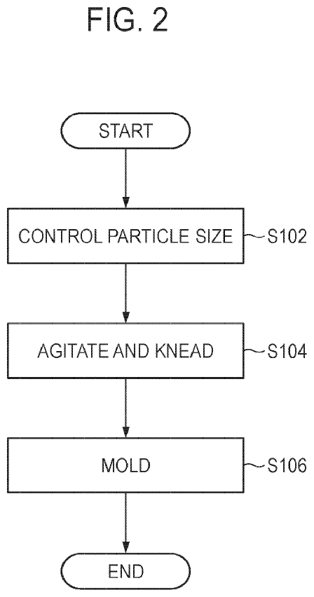

A ferrule and a method of manufacturing a ferrule according to an embodiment of the present invention will be described with reference to FIG. 1 and FIG. 2.

First, the ferrule according to the present embodiment will be described with reference to FIG. 1. FIG. 1 is a schematic diagram illustrating the ferrule according to the present embodiment. The ferrule according to the present embodiment is an optical connector ferrule used for an optical connector for optically connecting optical fibers. The ferrule according to the present embodiment is not particularly limited, but is, for example, a Mechanically Transferable (MT) ferrule. The optical connector in which the ferrule according to the present embodiment is used is not particularly limited, but is, for example, a MT connector, a Multifiber Push-On (MPO) connector, or the like.

As illustrated in FIG. 1, a plurality of optical fiber insertion holes 12 are formed in the ferrule 10 according to the present embodiment. A corresponding optical fiber 16 among a plurality of optical fibers 16 included in a secondary coated optical fiber 14 such as a fiber ribbon is inserted into each of the plurality of optical fiber insertion holes 12 and fixed by an adhesive or the like. The plurality of optical fiber insertion holes 12 are formed in the ferrule 10 so that the optical fibers 16 inserted into each of them are arranged in parallel with each other along the connection direction. The ferrule 10 has an end face 18 in which a plurality of optical fiber insertion holes 12 are opened so as to expose the end faces of the optical fibers 16 inserted into the plurality of optical fiber insertion holes 12. The end face 18 is polished by, for example, Physical Contact (PC) polishing, Super PC (SPC) polishing, Ultra PC (UPC) polishing, Angled PC (APC) polishing, or the like.

Note that the ferrule 10 need not necessarily be formed with a plurality of optical fiber insertion holes 12. When the secondary coated optical fiber 14 is a single core containing only a single fiber 16, the ferrule 10 may be formed with a single fiber insertion hole 12.

A pair of guide pin insertion holes 20 are formed in the ferrule 10. The pair of guide pin insertion holes 20 are formed in the ferrule 10 so as to be positioned on both sides of the plurality of optical fiber insertion holes 12. The pair of guide pin insertion holes 20 are respectively formed in the ferrule 10 along the connection direction of the optical fiber 16. A guide pin 22 for alignment is inserted into each of the pair of guide pin insertion holes 20.

The end faces 18 of the two ferrules 10 to be connected are brought into contact with each other so that the optical fiber insertion holes 12 corresponding to each other face each other and the guide pin insertion holes 20 corresponding to each other face each other. The guide pin 22 is inserted into the guide pin insertion holes 20 that face each other to align the two ferrules 10. The end faces of the optical fibers 16 exposed in the optical fiber insertion holes 12 that face each other are brought into contact with each other. Thus, the optical fibers 16 exposed in the optical fiber insertion holes 12 that face each other are optically connected. The two ferrules 10 having the end faces 18 in contact with each other are fixed by a fixing jig such as a clip. Note that the configuration for aligning and fixing the two ferrules 10 is not limited thereto. The two ferrules 10 may be aligned and fixed, for example, via an adapter.

The ferrule 10 according to the present embodiment consists of a resin composition containing a thermoplastic resin and a filler. Further, the ferrule 10 is such that the size of coarse particles originated from the filler is 50 μm or less or the size of aggregates originated from the filler is 50 μm or less, and preferably the size of the coarse particles originated from the filler is 25 μm or less or the size of the aggregates originated from the filler is 25 μm or less.

In the above descriptions, the coarse particles are originated from at least one of silica particles and carbon particles described later contained in the filler. Further, the aggregates are originated from at least one of the silica particles and the carbon particles described later contained in the filler. Specifically, the aggregates are at least one of the aggregates of the silica particles, the aggregate of the carbon particles, and the aggregates of the silica particles and the carbon particles. The ferrule 10 according to the present embodiment has excellent material homogeneity by not including at least one of the coarse particles and the aggregates exceeding a predetermined size originated from the filler.

In addition, in the above descriptions, the size of the coarse particles is the length of the longest portion measured in the image of the coarse particles observed by a microscope such as an optical microscope, and the size may be the length of the diameter of the coarse particles when the coarse particles are spherical, and the size may be the length of the long axis diameter when the coarse particles are of other shapes. Similarly, the size of the aggregates is the length of the longest portion measured in the image of the aggregates observed by a microscope such as an optical microscope, and the size may be the length of the diameter when the aggregates are spherical, and the size may be the length of the long axis diameter when the aggregates are of any other shape.

Each component contained in the resin composition constituting the ferrule 10 according to the present embodiment will be described below.

The thermoplastic resin is a matrix resin constituting a continuous phase of the ferrule 10. The thermoplastic resin is a resin having excellent precision moldability and is suitable as a matrix resin constituting a continuous phase of the ferrule 10 requiring precision molding. As the thermoplastic resin, a polyphenylene sulfide (PPS) resin, a polycarbonate (PC) resin, a polyether sulfone (PES) resin, a liquid crystal polymer (LCP), a modified polyphenylene ether (PPE), or the like may be used, and the PPS resin may be preferably used from the viewpoint of dimensional stability, strength, moldability, and the like. The PPS resin may have a crosslinked structure or a linear structure, and its structure, molecular weight and the like may be appropriately selected according to the characteristics required for the ferrule 10. As the thermoplastic resin, two or more kinds of mixtures selected from a plurality of kinds such as the PPS resin, the PC resin, the PES resin, and the like can be used.

The filler is particles contained in the resin composition for the purpose of reducing the molding shrinkage of the ferrule 10, reducing the linear expansion coefficient, improving the dimensional accuracy, and the like. The filler contains at least carbon particles and silica particles.

The maximum particle size D₁₀₀ of the filler is preferably 50 μm or less, more preferably 25 μm or less. The maximum particle size D₁₀₀ of the filler is the particle size of the largest particle in the filler. The maximum particle size D₁₀₀ of the filler is equal to the particle size in which the volume accumulated from the small particle size side in the particle size distribution by the volume reference of the concerned filler becomes the total volume. The maximum particle size D₁₀₀ of the filler may be obtained, for example, from particle size distribution measurement by laser diffraction/scattering method.

By setting the maximum particle size D₁₀₀ of the filler to the above range, coarse particles having a particle size exceeding the maximum particle size D₁₀₀ can be prevented from being contained in the resin composition. Thus, as described above, the ferrule 10 can be made such that the size of the coarse particles originated from the filler is 50 μm or less, and preferably the size of the coarse particles originated from the filler is 25 μm or less.

The cumulative 10% particle size D₁₀ of the filler is preferably 1 μm or more. The cumulative 10% particle size D₁₀ of the filler is a particle size in which the volume accumulated from the small particle size side in the particle size distribution by the volume reference of the concerned filler becomes 10% of the total volume. The cumulative 10% particle size D₁₀ of the filler may be obtained, for example, from particle size distribution measurement by laser diffraction/scattering method.

By setting the cumulative 10% particle size D₁₀ of the filler to the above range, fine particles which are particles having a particle size below the cumulative 10% particle size D₁₀ can be prevented from being assembled to form aggregates. Thus, as described above, the ferrule 10 can be made to contain no aggregate having a size of more than 50 μm originated from the filler, preferably no aggregate having a size of more than 25 μm originated from the filler.

In the case of the powdery filler, the filler can be classified such that the maximum particle size D₁₀₀ is preferably 50 μm or less, and more preferably the maximum particle size D₁₀₀ is 25 μm or less. Thus, the filler which does not contain the coarse particles of the size described above can be prepared.

In the case of the filler coarsely granulated with a particle size of about 0.5 mm to 2 mm, the filler can be crushed in advance before the filler is included in the resin composition. In this case, the crushing of the filler can be promoted by sufficiently agitating in the compound manufacture in which the respective components of the resin composition are agitated and kneaded, instead of the prior crushing processing or after the prior crushing processing. Even with these, it is possible to prepare the filler that does not contain coarse particles of the size described above.

On the other hand, in the case of the powdery filler, the filler can be classified to have the cumulative 10% particle size D₁₀ of preferably 1 μm or more. Thus, the fine powders in the filler can be prevented from being assembled to form the large aggregates as described above.

As described above, the filler having a desired particle size can be obtained by a method such as classification, crushing, agitating, or the like. Note that the method for obtaining the filler of the desired particle size is not particularly limited, and may be appropriately selected according to the type of filler or the like.

The silica particles contained in the filler are not particularly limited and may be spherical or amorphous. The maximum particle size D₁₀₀ of the silica particles is preferably 50 μm or less, more preferably 25 μm or less as described above. The cumulative 10% particle size D₁₀ of the silica particles is preferably 1 μm or more as described above.

The carbon particles contained in the filler are not particularly limited and may be carbon black, for example. The carbon particles may be, for example, carbon fine particles obtained by carbonizing and baking a resin such as a phenolic resin. The carbon black may be a carbon black obtained by an incomplete combustion method, a pyrolysis method, or the like. The maximum particle size D₁₀₀ of the carbon particles is preferably 50 μm or less, more preferably 25 μm or less as described above. The cumulative 10% particle size D₁₀ of the carbon particles is preferably 1 μm or more as described above. Note that, in the case where the carbon particles are carbon black, the maximum particle size D₁₀₀ and the cumulative 10% particle size D₁₀ referred to herein are for agglomerates (secondary aggregates), which consist of further combined aggregates (primary aggregates) consisting of primary carbon black particles fused together, respectively.

The content of silica particles and carbon particles in the resin composition is not particularly limited, but can be set in the following range from the viewpoint of eliminating large coarse particles and aggregates while realizing the purpose of including the filler such as reducing molding shrinkage. That is, the resin composition can preferably contain 150 parts by mass or more and 400 parts by mass or less of the silica particles and 0.5 parts by mass or more and 4 parts by mass or less of the carbon particles for 100 parts by mass of the thermoplastic resin, and can more preferably contains 150 parts by mass or more and 300 parts by mass or less of the silica particles and 0.5 parts by mass or more and 1.5 parts by mass or less of the carbon particles for 100 parts by mass of the thermoplastic resin.

The silica particles and the carbon particles contained in the filler may be surface treated with a silane coupling agent or the like when kneading the silica particles and the carbon particles with the thermoplastic resin or the like for the purpose of securing adhesiveness with the thermoplastic resin. By adding the silane coupling agent, the adhesion between the silica particles contained in the filler and the resin composition can be prevented from decreasing, and the filler not adhering to the resin composition in the resin composition can be reduced, and the reduction of the breaking strength of the resin composition can be avoided.

Note that the filler may include particles other than the silica particles and the carbon particles. For example, the filler may include particles such as whisker-like calcium carbonate or the like. The strength of the filler can be improved by adding whisker-like calcium carbonate.

As described above, the ferrule 10 is composed of the resin composition containing the thermoplastic resin and the filler containing at least the silica particles and the carbon particles. Note that the resin composition may contain any optional component other than the thermoplastic resin and the filler.

For a ferrule for an optical fiber such as an MT ferrule, it is required to control the position and diameter of the guide pin insertion hole, the optical fiber insertion hole and the like with a high accuracy of sub-microns. Therefore, excellent characteristics such as high dimensional stability and high mold transferability are required for the resin composition constituting the ferrule.

Generally, the resin composition constituting the ferrule contains not only a base resin such as a thermoplastic resin, but also a filler such as silica particles and carbon particles for the purpose of reducing molding shrinkage, reducing linear expansion coefficient, improving dimensional accuracy, and the like. On the other hand, due to the filler, the ferrule material may contain large coarse particles or large aggregates. The presence of large coarse particles or large aggregates in the ferrule material impairs its homogeneity. When the material homogeneity is impaired, the ferrule may become brittle, the ferrule end face may become less polished, and the temperature characteristics of optical connection loss may deteriorate due to the loss of isotropy of the linear expansion coefficient.

In contrast, the ferrule 10 according to the present embodiment is superior in the material homogeneity because, as described above, the size of the coarse particles originated from the filler is 50 μm or less or the size of the aggregates originated from the filler is 50 μm or less. In the present embodiment, the particle size of the filler is specified so that the maximum particle size D₁₀₀ of the silica particles and the carbon particles contained in the filler is 50 μm or less in order to prevent incorporation of the coarse particles. In the present embodiment, the particle size of the filler is specified so that the cumulative 10% particle size D₁₀ of the silica particles and the carbon particles is 1 μm or more in order to prevent the occurrence of such aggregates. Thus, the ferrule 10 according to the present embodiment has a higher strength and a higher polishing property of the end face 18. Furthermore, the ferrule 10 according to the present embodiment has a better temperature characteristic of optical connection loss.

Next, a manufacturing method of the ferrule 10 according to the present embodiment will be described with reference to FIG. 2. FIG. 2 is a flowchart illustrating the manufacturing method of the ferrule 10 according to the present embodiment.

First, for each of the silica particles and the carbon particles contained in the filler, the particle size is controlled so that the maximum particle size D₁₀₀ is preferably 50 μm or less, more preferably 25 μm or less, and the cumulative particle 10% size D₁₀ is preferably 1 μm or more (Step S102). For controlling the particle size, appropriate processing such as crushing by a crusher, grinding by a grinder, classification by a classifier, or the like can be used. Further, for controlling the particle size, it is possible to use the fact that the particle size decreases as the particles are agitated and kneaded in agitation and kneading in the next Step S104.

Next, a thermoplastic resin, silica particles, carbon particles, a silane coupling agent, and other necessary components are blended in predetermined amounts and agitated using a Henschel mixer, or the like, and then all the components are kneaded using a twin-screw kneading extruder to prepare a resin composition (Step S104). Note that the method of agitating all the components is not limited to the method using a Henschel mixer, but any appropriate method can be used. The method of kneading all components is not limited to the method using a twin-screw kneading extruder, but any appropriate method can be used. In Step S104, it is not necessary to perform both agitating and kneading, but only one of the two processes can be performed.

Next, the prepared resin composition is molded by injection molding to manufacture the ferrule 10 made of the resin composition (Step S106). Note that the molding method for molding the resin composition is not limited to injection molding, and any appropriate method can be used depending on the composition of the resin composition, and the like. Thus, the ferrule 10 can be manufactured in which the size of the coarse particles due to the filler is 50 μm or less or the size of the aggregates due to the filler is 50 μm or less, and preferably the size of the coarse particles due to the filler is 25 μm or less or the size of the aggregates due to the filler is 25 μm or less.

### EXAMPLES

Next, examples of the present invention will be described. Note that the examples do not limit the present invention but are indicative of some of the application examples of the present invention.

MT ferrules were fabricated as ferrules for optical fibers. In the preparation of the MT ferrule, the following materials were prepared as components of the resin composition. As the thermoplastic resin, a crosslinked polyphenylene sulfide resin (made by DIC Corporation, melt viscosity 27 Pa·s (equivalent to JIS K-7210, measurement temperature 300° C., load 20 kgf, die 1.0 mm×10 mm)) was prepared. A high purity spherical silica filler (made by Tatsumori Ltd.) was prepared as the silica particles that was the filler. As the carbon particles that was the filler, a TOKABLACK #7360SB (product name, made by Tokai Carbon Co., Ltd.) which was a carbon black for coloring was prepared.

The thermoplastic resin, the silica particles and the carbon particles in the blending amounts shown in Tables 1 and 2 below, and the silane coupling agent were blended, and compounded in a twin-screw kneading extruder to prepare resin compositions of Examples 1 to 8 and Comparative Examples 1 to 6. Note that in Examples 1 to 5 and Comparative Examples 1 to 3, the respective particles were classified before compounding so that the maximum particle sizes D₁₀₀ of the silica particles and the carbon particles would be the values shown in Table 1, respectively. Note also that in Examples 6 to 8 and Comparative Examples 4 to 6, the respective particles were classified prior to blending so that the cumulative 10% particle sizes D₁₀ of the silica particles and the carbon particles would be the values shown in Table 2, respectively. These resin compositions were molded by injection molding to fabricate MT ferrules made of the respective resin compositions.

The end faces of the fabricated MT ferrules were polished by about 50 μm thickness, and the number and size of the coarse particles exposed on the polished end faces were evaluated in Examples 1 to 5 and Comparative Examples 1 to 3, and the number and size of aggregates exposed on the polished end faces were evaluated in Examples 6 to 8 and Comparative Examples 4 to 6. For Examples 1 to 8 and Comparative Examples 1 to 6, the end faces of 12 MT ferrules per polishing were polished 84 times by a polishing machine, and the total of the end faces of 1008 MT ferrules were prepared as evaluation targets.

In the evaluation of the coarse particles, the entire polished end face of the MT ferrule was observed with an optical microscope for the Examples 1 to 5 and Comparative Examples 1 to 3, and the number of the coarse particles larger than 50 μm in size and the number of the coarse particles larger than 25 μm in size were counted and evaluated. In the evaluation results, “excellent” was given for an example without any coarse particle larger than 25 μm in size, “good” was given for an example without any coarse particle larger than 50 μm in size, and “bad” was given for an example with even one coarse particle larger than 50 μm in size. The results of these evaluations are shown in Table 1. Table 1 also shows the probability of the occurrence of the coarse particles larger than 50 μm in size and the probability of the occurrence of the coarse particles larger than 25 μm in size for each example. The probability of the occurrence of the coarse particles is expressed as a percentage of the number of MT ferrules in which the coarse particles larger than the size concerned were observed to the total number of the 1008 ferrules evaluated.

In the evaluation of the aggregates, the entire polished end face of the MT ferrule was observed with an optical microscope for Examples 6 to 8 and Comparative Examples 4 to 6, and the number of the aggregates larger than 50 μm in size and the number of the aggregates larger than 25 μm in size were counted and evaluated. In the evaluation results, “excellent” was given for an example without any aggregate larger than 25 μm in size, “good” was given for an example without any aggregate larger than 50 μm in size, and “bad” was given for an example with even one aggregate larger than 50 μm in size. The results of these evaluations are shown in Table 2. Table 2 also shows the probability of the occurrence of the aggregates larger than 50 μm in size and the probability of the occurrence of the aggregates larger than 25 μm in size for each example. The probability of the occurrence of the aggregates is expressed as a percentage of the number of MT ferrules in which the aggregates larger than the size concerned were observed to the total number of the 1008 ferrules evaluated.

TABLE 1

| | | | | | | Probability of | Probability of | |
|---|---|---|---|---|---|---|---|---|
| | Blending amount | | | Particle size | | occurrence of | occurrence of | |
| | Thermoplastic | Silica | Carbon | D₁₀₀ of | D₁₀₀ of | coarse particles | coarse particles | |
| | resin | particles | particles | Silica | Carbon | larger than | larger than | |
| | (Parts by | (Parts by | (Parts by | particles | particles | 50 μm | 25 μm | Evaluation |
| | mass) | mass) | mass) | (μm) | (μm) | (%) | (%) | Result |
| Example 1 | 100 | 400 | 4.0 | 50 | 50 | 0 | 23 | Good |
| Example 2 | 100 | 240 | 0.5 | 50 | 25 | 0 | 12 | Good |
| Example 3 | 100 | 300 | 2.0 | 50 | 10 | 0 | 11 | Good |
| Example 4 | 100 | 150 | 1.5 | 25 | 50 | 0 | 13 | Good |
| Example 5 | 100 | 300 | 1.5 | 25 | 25 | 0 | 0 | Excellent |
| Comparative | 100 | 230 | 1.0 | 25 | 60 | 5 | 10 | Bad |
| example 1 | | | | | | | | |
| Comparative | 100 | 280 | 2.0 | 60 | 20 | 5 | 9 | Bad |
| example 2 | | | | | | | | |
| Comparative | 100 | 360 | 1.3 | 20 | 100 | 24 | 36 | Bad |
| example 3 | | | | | | | | |

TABLE 2

| | | | | | | Probability of | Probability of | |
|---|---|---|---|---|---|---|---|---|
| | Blending amount | | | Particle size | | occurrence of | occurrence of | |
| | Thermoplastic | Silica | Carbon | D₁₀₀ of | D₁₀₀ of | coarse particles | coarse particles | |
| | resin | particles | particles | Silica | Carbon | larger than | larger than | |
| | (Parts by | (Parts by | (Parts by | particles | particles | 50 μm | 25 μm | Evaluation |
| | mass) | mass) | mass) | (μm) | (μm) | (%) | (%) | Result |
| Example 6 | 100 | 200 | 2.5 | 1.0 | 1.0 | 0 | 8 | Good |
| Example 7 | 100 | 350 | 2.5 | 3.0 | 2.0 | 0 | 0 | Excellent |
| Example 8 | 100 | 150 | 2.0 | 1.0 | 1.5 | 0 | 7 | Good |
| Comparative | 100 | 200 | 0.8 | 1.2 | 0.56 | 25 | 14 | Bad |
| example 4 | | | | | | | | |
| Comparative | 100 | 160 | 1.0 | 0.87 | 1.1 | 19 | 9 | Bad |
| example5 | | | | | | | | |
| Comparative | 100 | 180 | 1.6 | 0.38 | 0.54 | 35 | 16 | Bad |
| example 6 | | | | | | | | |

From the above evaluation results for the coarse particles, it was confirmed that controlling the maximum particle size D₁₀₀ of the filler within the predetermined range can prevent the incorporation of coarse particles that are larger than the predetermined size. In addition, from the above evaluation results for the aggregates, it was confirmed that controlling the cumulative 10% particle size D₁₀ of the filler within the predetermined range can prevent the generation of aggregates larger than the predetermined size. By taking these evaluation results together, it was confirmed that controlling the maximum particle size D₁₀₀ and the cumulative 10% particle size D₁₀ of the filler within the predetermined range can prevent the incorporation of coarse particles larger than the predetermined size and the generation of aggregates larger than the predetermined size.

What is claimed is:

1. A ferrule formed with an optical fiber insertion hole into which an optical fiber is inserted,
the ferrule comprising a resin composition containing a thermoplastic resin and a filler,
wherein a size of coarse particles originated from the filler is 50 μm or less, or a size of aggregates originated from the filler is 50 μm or less.

2. The ferrule according to claim 1, wherein the size of the coarse particles is 25 μm or less or the size of the aggregate is 25 μm or less.

3. The ferrule according to claim 1, wherein a maximum particle size D₁₀₀ of the silica particles is 50 μm or less.

4. The ferrule according to claim 1, wherein a maximum particle size D₁₀₀ of the carbon particle is 50 μm or less.

5. The ferrule according to claim 1, wherein a cumulative 10% particle size D₁₀ of the silica particles is 1 μm or more.

6. The ferrule according to claim 1, wherein a cumulative 10% particle size D₁₀ of the carbon particles is 1 μm or more.

7. The ferrule according to claim 1, wherein the resin composition contains 150 parts by mass or more and 400 parts by mass or less of the silica particles and 0.5 parts by mass or more and 4 parts by mass or less of the carbon particles for 100 parts by mass of the thermoplastic resin.

8. The ferrule according to claim 7, wherein the resin composition contains 150 parts by mass or more and 300 parts by mass or less of the silica particles and 0.5 parts by mass or more and 1.5 parts by mass or less of the carbon particles for 100 parts by mass of the thermoplastic resin.

9. The ferrule according to claim 1, wherein the carbon particles are carbon black.

10. The ferrule according to claim 1, wherein the silica particles are spherical or amorphous.

11. A method for manufacturing a ferrule having formed with an optical fiber insertion hole into which an optical fiber is inserted, the method comprising:
controlling particle size of a filler containing at least silica particles and carbon particles;
preparing a resin composition containing a thermoplastic resin and the filler; and
molding the resin composition to manufacture the ferrule comprising the resin composition, wherein a size of coarse particles originated from the filler is 50 μm or less, or a size of aggregates originated from the filler is 50 μm or less.
